(19) United States
(12) Patent Application Publication
(10) Pub. No.: US 2007/0119890 A1
(43) Pub. Date: May 31, 2007

(54) Storage device

(76) Inventor: Grace L. Cook, Lansing, MI (US)

Correspondence Address: PAPARELLA & ASSOCIATES, PLC, 930 N. WASHINGTON AVE., LANSING, MI, 48906, US

(21) Appl. No.: 11/288,570

(22) Filed: Nov. 29, 2005

(51) Int. Cl. B60R 7/00; B60R 11/00; B60R 9/00

(52) U.S. Cl. 224/543

(57) ABSTRACT

A storage device for restraining items on a vehicle includes a panel portion comprising at least one storage receptacle and a conforming portion adapted to fit adjacent at least one generally non-planar portion of a vehicle, the at least one generally non-planar portion protruding from a vehicle surface. The storage device is adapted to be suspended from the vehicle surface, wherein the storage device conforms to and lies substantially against the vehicle surface including the at least one generally non-planar portion.

### BACKGROUND OF THE INVENTION

The present invention relates to a storage device generally, and more specifically to a storage device suitable for use with a vehicle.

Small utility vehicles, also known as grounds maintenance utility vehicles, maintenance utility vehicles, tractors, golf carts, farm utility vehicles, and the like, are typically motorized vehicles, which are used to conveniently transport the vehicles occupants across an area that would otherwise be inconvenient to walk to or through. These vehicles are used in numerous situations, for numerous activities, and can be used either for pleasure or for work. One such use is to help the grounds-keeper with their job. As such, these MUV's are typically loaded with the groundskeepers tools, other implements, and supplies of the trade. However, currently there is no way to easily secure and transport these tools and supplies in the MUV. As such, someone utilizing such a mobile vehicle will typically position these tools and supplies either on the floor of the MUV, or in the adjacent seat, if so provided. Unfortunately, this method of transporting tools within the MUV allows the tools to intermingle and roll around, becoming disorganized and no longer easily accessible. Additionally, these unsecured tools can move around during the operation of the MUV and fall from their initial position, or even fall outside of the MUV. Worse yet, the unsecured tools can act as a projectile if the MUV is stopped in an abrupt manner, thereby creating a safety hazard for the vehicles occupants, as well as others.

Accordingly, a need exists for a storage device for use in a MUV that can, among other things, organize and retain tools and supplies, thereby keeping the tools and supplies organized, as well as allowing easy access thereto. Therefore, a storage device that solves the aforementioned disadvantages and having the aforementioned advantages is desired.

### SUMMARY OF THE PRESENT INVENTION

A storage device for restraining items on a vehicle includes, a panel portion comprising a first surface and a second surface adjacently disposed in opposite relation thereto. The first surface includes at least one storage receptacle thereon. The storage device also includes a conforming portion which is adapted to fit adjacent at least one generally non-planar portion of a vehicle, the at least one generally non-planar portion protruding from a vehicle surface. The storage device is adapted to be suspended from the vehicle surface such that when the second surface is disposed adjacent the vehicle surface, and the conforming portion is disposed adjacent the generally non-planar portion, the storage device conforms to and lies substantially against the vehicle surface which includes the at least one generally non-planar portion.

Another aspect of the present invention includes a conforming storage device for use in storing and organizing items on a vehicle body surface. The vehicle body surface includes a generally planar portion and at least one non-planar portion extending from the vehicle body surface. The storage device includes a panel portion comprising a first surface and a second surface adjacently disposed in opposite relation, the first surface comprising at least one storage receptacle. A conforming portion is also included, the conforming portion being adapted to conform to the at least one non-planar portion extending from the vehicle body surface. The panel portion is adapted to be suspended from the vehicle body surface such that when the second surface is disposed adjacent the vehicle body surface and the conforming portion is disposed adjacent the at least one non-planar portion extending from the vehicle body surface, the storage device conforms to and lies substantially against the vehicle body surface including the generally planar portion, and the at least one non-planar portion extending from the vehicle body surface.

In another aspect of the present invention, a storage device is adapted to be suspended in a maintenance utility vehicle, wherein the maintenance utility vehicle includes a cab structure, a pair of bucket style seats within the cab structure, and a generally vertical wall surface located behind the pair of bucket style seats. The generally vertical wall surface includes a generally planar portion and a pair of non-planar portions extending from the generally vertical wall surface. The storage device includes a panel portion comprising a first surface and a second surface adjacently disposed in opposite relation, wherein the first surface comprises a plurality of storage receptacles. A pair of conforming flaps, each conforming flap adapted to fit over and conform to each non-planar portion, extends from the generally vertical wall surface. Further, the panel portion is adapted to be suspended from the generally vertical wall surface such that when the second surface is disposed adjacent the generally vertical wall surface, and each conforming portion is disposed over each non-planar portion extending from the vehicle body surface, the storage device conforms to and lies substantially against the generally vertical wall surface including the generally planar portion, and the pair of non-planar portions extending from the generally vertical wall surface.

Other objects, advantages, and features of the invention will become apparent upon consideration of the following detailed description, when taken in conjunction with the accompanying drawings. The above brief description sets forth rather broadly the more important features of the present disclosure so that the detailed description that follows may be better understood, and so that the present contributions to the art may be better appreciated. There are, of course, additional features of the disclosures that will be described hereinafter which will form the subject matter of the claims.

In this respect, before explaining the preferred embodiment of the disclosure in detail, it is to be understood that the disclosure is not limited in its application to the details of the construction and the arrangement set forth in the following description or illustrated in the drawings. The storage device of the present disclosure is capable of other embodiments and of being practiced and carried out in various ways. Also, it is to be understood that the phraseology and terminology employed herein are for description and not limitation. Where specific dimensional and material specifications have been included or omitted from the specification or the claims, or both, it is to be understood that the same are not to be incorporated into the claims.

As such, those skilled in the art will appreciate that the conception, upon which this disclosure is based, may readily be used as a basis for designing other structures, methods, and systems for carrying out the several purposes of the present invention. It is important, therefore, that the claims are regarded as including such equivalent constructions as far as they do not depart from the spirit and scope of the present invention.

Further, the purpose of the Abstract is to enable the U.S. Patent and Trademark Office and the public generally, and especially the scientists, engineers, and practioners in the art who are not familiar with the patent or legal terms of phraseology, to learn quickly from a cursory inspection the nature and essences of the technical disclosure of the application. Accordingly, the Abstract is intended to define neither the invention nor the application, which is only measured by the claims, nor is it intended to be limiting as to the scope of the invention in any way.

These and other objects, along with the various features, and structures that characterize the invention, are pointed out with particularity in the claims annexed to and forming a part of this disclosure. For a better understanding of the storage device of the present disclosure, its advantageous and the specific objects attained by its uses, reference should be made to the accompanying drawings and descriptive matter in which there are illustrated and described the preferred embodiments of the invention.

While embodiments of the storage device are herein illustrated and described, it is to be appreciated that various changes, rearrangements and modifications maybe made therein, without departing from the scope of the invention as defined by the claims.

### BRIEF DESCRIPTION OF THE DRAWINGS

FIG. 1 is a front view of one preferred embodiment of a storage device of the present invention;

FIG. 2 is a perspective view of the storage device of FIG. 1 installed on a typical MUV, wherein the MUV is shown in a fragmentary perspective view;

FIG. 3 is an enlarged fragmentary front view of the storage device of FIG. 1 illustrating a conforming portion;

FIG. 4 is an enlarged fragmentary perspective view of the storage device of FIG. 2, illustrating the conforming portion;

FIG. 5 is a front view of a second preferred embodiment of the storage device of the present invention;

FIG. 6 is a perspective view of the storage device of FIG. 5 installed on a typical MUV, wherein the MUV is shown in a fragmentary perspective view;

FIG. 7 is an enlarged fragmentary perspective view of the storage device of FIG. 6 illustrating a conforming portion;

FIG. 8 is a fragmentary sectional view illustrating the storage device mounted behind a typical MUV seat.

### DETAILED DESCRIPTION OF THE PREFERRED EMBODIMENT

The best mode for caring out the invention is presented in terms of the preferred embodiment, wherein similar referenced characters designate corresponding features throughout the several figures of the drawings.

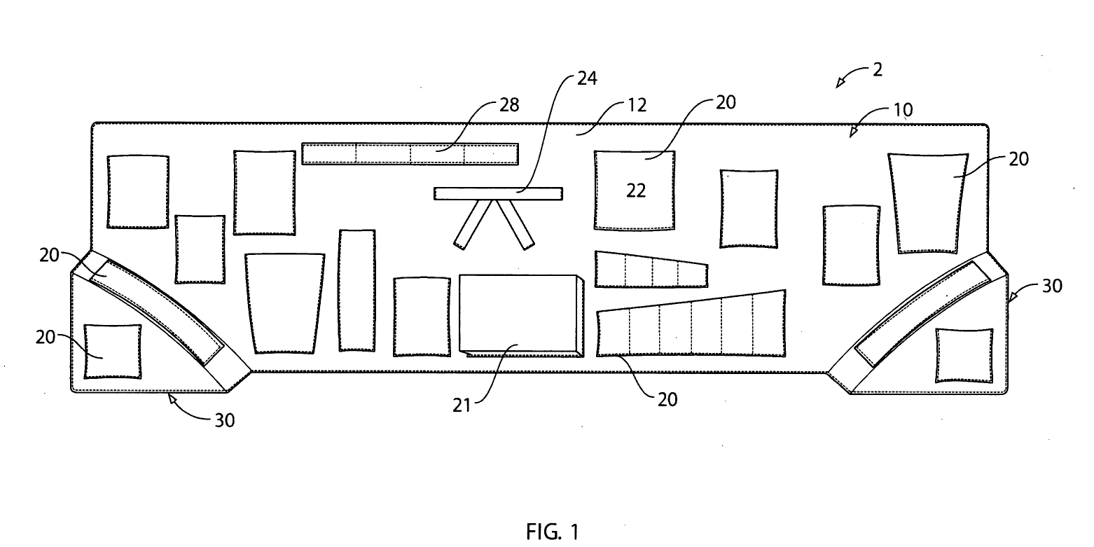

For purposes of description herein, the terms “upper”, “lower”, “right”, “left”, “rear”, “front”, “vertical”, “horizontal”, and derivatives thereof, shall relate to the invention as oriented in FIG. 1. However, it is to be understood that the invention may assume various alternative orientations, except where expressly specified to the contrary. It is also to be understood that the specific devices and processes illustrated in the attached drawings and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

Reference will now be made in detail to the present preferred embodiments of the invention, examples of which are illustrated in the accompanying drawings. Wherever possible, these same referenced numerals will be used throughout the drawings to refer to the same or like parts. The dimensions illustrated in the drawings (if provided) are included for purposes of example only and are not intended to limit the scope of the present invention. Additionally, particular details in the drawings which are illustrated in hidden or dashed lines are to be considered as forming no part of the present invention.

As used herein, the term maintenance utility vehicle, or MUV, is meant to refer to vehicles such as grounds maintenance utility vehicles, tractors, golf carts, farm utility vehicles, and the like. These vehicles are typically motorized vehicles which are used to conveniently transport the vehicles occupants across an area which would otherwise be inconvenient to walk to, or through. These vehicles are used in numerous situations, for numerous activities and can be used either for pleasure or for work. For example only, one such use is to help a grounds-keeper in the performance of their job, and for brevity, we will discuss herein the inventive storage device as it works with and relates to a grounds maintenance utility vehicle. Of course, this is not meant to be limiting in any manner and these vehicles may take on numerous other configurations, and may be used for numerous other purposes.

At present, there is no easy way to secure and transport tools, supplies, and other equipment within a maintenance utility vehicle. As such, storage device 2 was developed to solve this problem and is generally used to secure and organize these tools and supplies within the MUV during the operation thereof. The current method for storing tools within these vehicles is to position, dispose, or simply toss these tools on the floor of the MUV, or in the adjacent seat if so provided. Unfortunately, this method of transporting the tools within the MUV allows the tools to intermingle and roll around, thereby becoming disorganized and no longer easily accessible. Additionally, many of these MUV's do not use a side door. As such, these unsecured tools may fall outside of the MUV during operation. Worse yet, the unsecured tools can act as a projectile if the MUV is stopped in an abrupt manner, thereby creating a safety hazard for the vehicles occupants, as well as others.

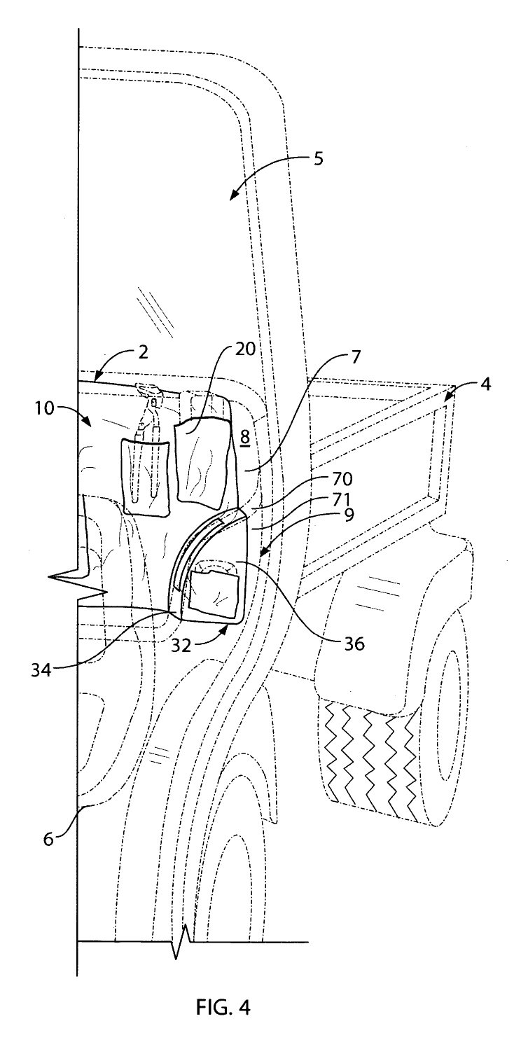

Although the MUV is not meant to be part of the present invention and is in no way meant to be limited by this discussion, it will be beneficial for the reader to discuss some of the terminology as it relates to the MUV. A typical MUV 4 will have some sort of a cab structure 5 which is generally used to hold and shelter the driver and it occupants. Cab structure 5 may be either open or closed and will typically include one or more bucket style seats 6. As used herein, a bucket style seat means a seat that is that does not extend the majority of the width of a cab. Of course, bench style seating may also be used. Within cab structure 5, and located behind seats 6, is a generally vertical wall surface 7 which typically separates the cab from the rear of the vehicle. As is typically the case, vehicle surface 7 is generally planar but will usually have one or more portions or surfaces 9 that are non-planar, and may either protrude from surface 7 into cab 5, or are recessed into surface 7 and extend out of cab 5. These non-planar portions 9 may be, for example, wheel-wells, frames structures, roll bars, etc., that are formed into or around surface 7, thereby dividing surface 7 into planar portions 8 and non-planar portions 9 (see FIG. 4). For example, in one currently available MUV, vertical surface 7 is generally planar in shape except for two regions 9 disposed on opposite sides of cab 5, which are part of the vehicles frame and which create two protruding areas or non-planar portions 9 that protrude from or extend out of the generally planar surface 8 of vehicle surface 7. Heretofore, storage devices have not been able to conform to these non-planar portions of a vehicle, whether an MUV, or any other type of vehicle. However, storage device 2, because of conforming portion 30, will allow storage device 2 to conform over or around these non-planar portions 9, thereby allowing storage device 2 to correctly fit these contoured surfaces.

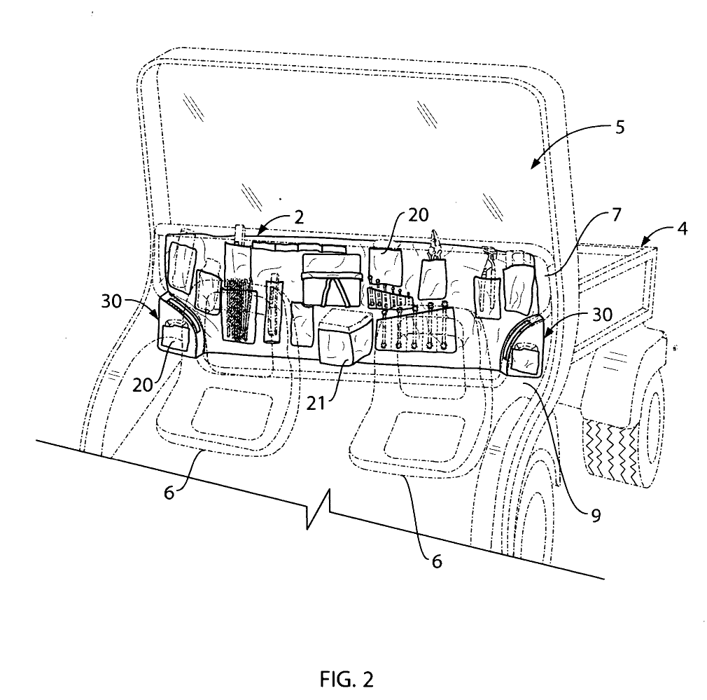

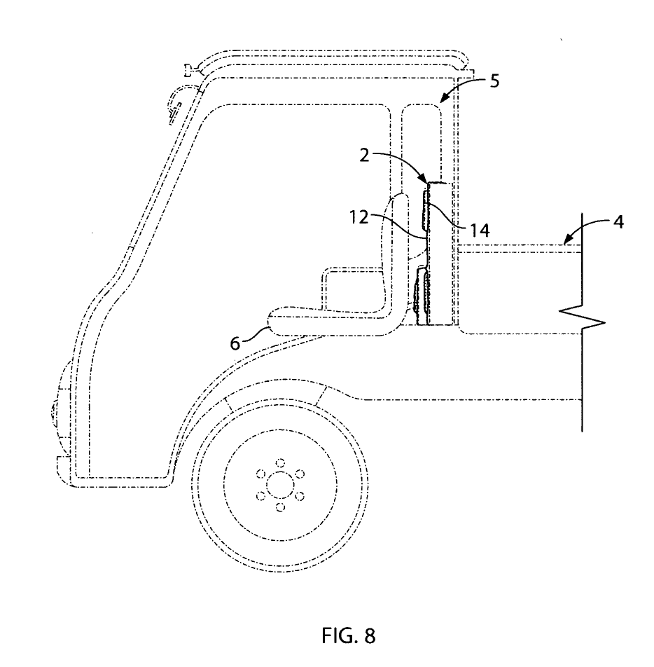

Additionally, because MUV's are typically much smaller than a regular sized vehicle, there is usually not much room behind seat 6 for the storage of items. This wasted space is exacerbated by protruding portions 9 which extend into the cab structure 5. However, the present invention solves this problem by conforming to protrusions 9, thereby allowing this previously unused area to be utilized for the storage of tools and the like. For example, storage receptacle 20 may be dimensioned so as to be capable of storing an item having a depth no larger than the smallest distance between the rear of the back of seat 6, and the first surface 12 of storage device 2 where storage receptacle 20 is so positioned when storage device 2 is suspended from vehicle surface 7, thereby allowing unrestricted adjustment of seat 6 while still permitting storage therebehind (FIG. 8). Further yet, a storage receptacle 21 may be so dimensioned so as to be capable of storing an item having a depth at least as large as the largest distance between the rear of the back of seat 6, and vertical surface 7, thereby allowing large items, that is to say larger than what can be stored behind the seat when the seat is positioned farthest away from surface 5, to be stored at a side of seat 6, between bucket seats 6, as illustrated in FIG. 2. Of course, storage receptacle 2 may be disposed on other locations either inside of or outside cab 5 and storage receptacles 20 may have various shapes, sizes and configurations and this in no way is meant to be limiting.

The disadvantages and drawbacks of the prior art are overcome through the storage device of the present invention, wherein one preferred embodiment is disclosed in FIGS. 1-4. Referring now to FIG. 1, there is shown a storage device 2 of the present invention. A storage device 2 for restraining items on, for example, a maintenance utility vehicle 4, includes a panel portion 10 comprising a first surface 12, and a second surface 14 adjacently disposed in opposite relation thereto. The first surface 12 includes at least one storage receptacle 20. Storage device 2 also includes a conforming portion 30 which is adapted to fit adjacent at least one generally non-planar portion 9 of vehicle 4. As used herein, the term non-planar portion is meant to include any surface that protrudes from, or is recessed into, the vehicle surface upon which the storage receptacle is mounted. For example, these non-planar surfaces 9 may protrude from a vehicle surface 7 into a cab structure 5 of MUV 4. These non-planar portions 9 may be, for example, wheel wells, frame structures, roll bars, housings, etc., that are formed into or around surface 7 upon which storage device 2 will be supported. Consequently, surface 7 may be further divided into portions 8, referred to herein as planar portion 8, although they need not be planar, and non-planar portions 9. Storage device 2 is adapted to be suspended from vehicle surface 7 such that when second surface 14 is disposed adjacent vehicle surface 7, and conforming portion 30 is disposed adjacent the generally non-planar portion 9, storage device 2 will conform to and lie substantially against vehicle surface 7, including the at least one generally non-planar portion 9.

The specific configurations and features of storage device 2 may vary according to specific requirements. In one preferred embodiment, storage device 2 is generally rectangular in shape and is fabricated by stitching a generally pliable material, such as a fabric, canvas, or the like, into a one-piece configuration. However, the shape of storage device 2 may vary according to specific requirements and need not be rectangular in configuration. Further, although one preferred embodiment of storage device 2 is fabricated from a pliable material, other materials, pliable or rigid, and other fabrication techniques may be used. In addition, although this particular embodiment of storage device 2 is fabricated into a one-piece configuration, multiple piece configurations may also be utilized.

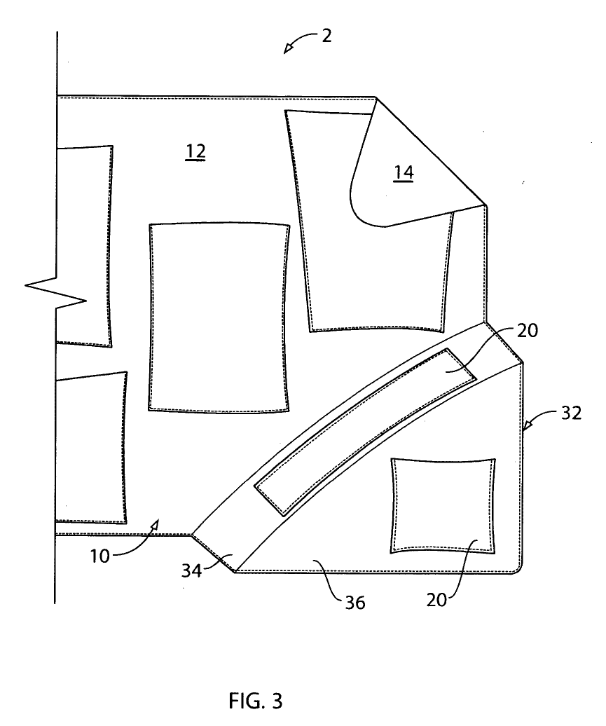

Storage device 2 comprises panel portion 10 which includes first surface 12 and second surface 14 (see FIG. 3) adjacently disposed in opposite relation thereto. For example, first surface 12 may be the front surface, that is to say, the surface used to hold the tools, and second surface 14 may be the surface that is disposed adjacent surface 7 which is used to retain storage device 2. As best illustrated in FIGS. 1 and 2, first surface 12 includes at least one storage receptacle 20. Storage receptacle 20 may take on various shapes, sizes and configurations. For example, storage receptacle 20 may be configured as a pocket 22, a tie down 24, or a loop 28. Of course, other various shapes, sizes and configurations may be utilized, and this in no way is meant to be limiting. As such, the term receptacle as used herein, means anything which can contain, hold, restrain, or organize and is not meant to be limited to a “pocket” or other particular receptacle or enclosure.

Storage device 2 also includes conforming portion 30 (FIG. 2) which is adapted to fit adjacent at least one generally non-planar portion 9 of vehicle 4. As used herein, conforming portion 30 is meant to include the one or more portions of storage device 2 which are specifically fabricated to conform to or around the non-planar portions 9 of vehicle surface 7. For example, conforming portion 30 may be a flap which is fabricated to be a part of storage device 2, wherein the flap is designed to substantially conform to and lie flat against non-planar portion 9 of vehicle surface 7 to which storage device 2 is disposed. On the other hand, conforming portion 30 may also be an opening which is designed to substantially outline the non-planar portion 9 so as to not interfering with non-planar portion 9. As described previously, the obstacle or non-planar portion 9 may be a wheel-well housing, frame, or other protrusion, as well as any other obstacle that either intrudes into or out of vehicle surface 7.

As best seen in FIGS. 3 and 4, in one embodiment, conforming portion 30 includes a conforming flap 32 which includes a first portion 34 which is generally perpendicular to panel portion 10, and a second portion 36 which is generally parallel to panel portion 10 when storage device 2 is installed on vehicle surface 7. Typically, storage device 2 is adapted to be suspended from vehicle surface 7 such that second surface 14 is disposed adjacent vehicle surface 7, and conforming portion 30 is disposed adjacent or over non-planar portion 9 so that storage device 2 conforms to and lies substantially against vehicle surface 7 including non-planar portion 9. In this particular embodiment, conforming flap 32 is configured to fit over non-planar portion 9 such that storage device 2 conforms to and lies substantially over vehicle surface 7 and non-planar portion 9. This conformance is accomplished by having first portion 34 (FIG. 4), which is generally perpendicular to panel portion 10, rest on a segment 70 of non-planar portion 9 which is generally perpendicular to planar portion 8 of vehicle surface 7. Simultaneously, second portion 36, which is generally parallel to panel portion 10, lies against a segment 71 of non-planar portion 9 which is generally parallel with planar portion 8 of vehicle surface 7. In this manner, storage device 2 conforms to and lies substantially over all of vehicle surface 7 including the contours contained thereon. Additionally, first portion 34 and second portion 36 may have, either alone or in conjunction, storage receptacles 20 disposed thereon which may help to keep conforming flap 32 disposed on non-planar portion 9.

While one preferred embodiment has been described, the specific characteristics of storage device 2 may vary according to the specific requirements of the end user. Although one preferred embodiment utilizes a generally rectangular shape and is fabricated from a pliable material such as vinyl or canvas. Storage device 2 may be fabricated from numerous parts and in numerous shapes. As illustrated, storage device 2 is fabricated into a one-piece configuration by stitching one or more storage receptacles 20 onto first surface 12. However, the shape of storage device 2 may vary according to specific requirements. Further, although one preferred embodiment is fabricated from a fabric material by utilizing sewing techniques, other materials and fabrication techniques may be used.

By fabricating storage device 2 from a generally pliable fabric material, a very economical storage device has been developed which is simple in configuration and appearance, yet strong and extremely functional in nature. In addition, storage device 2 may be removably mounted and therefore, carried from one MUV to another. Further yet, due to the pliability of this embodiment, storage device 2 can be rolled up for easy transportation or storage.

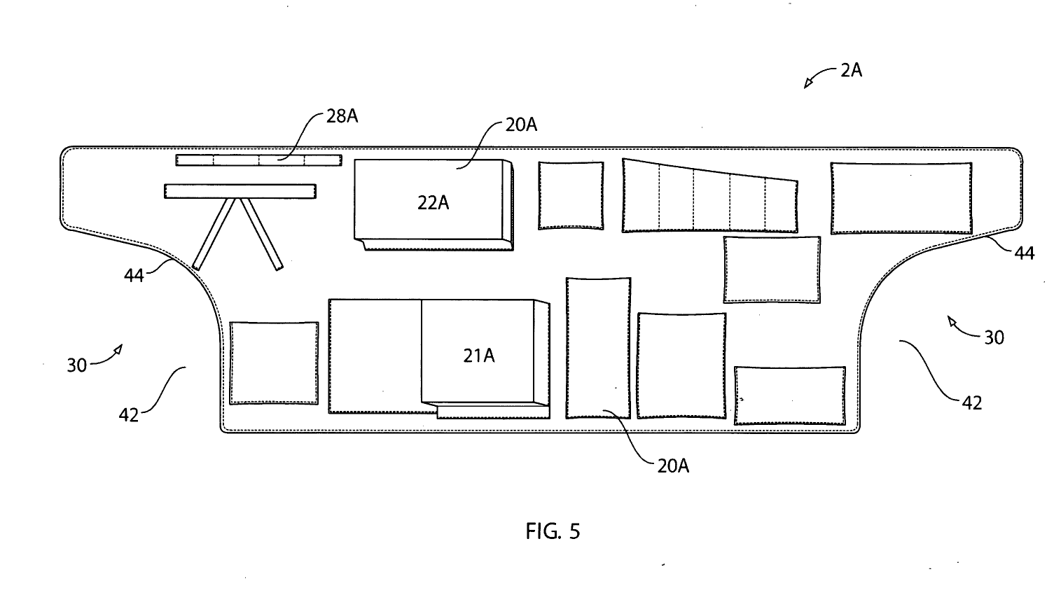

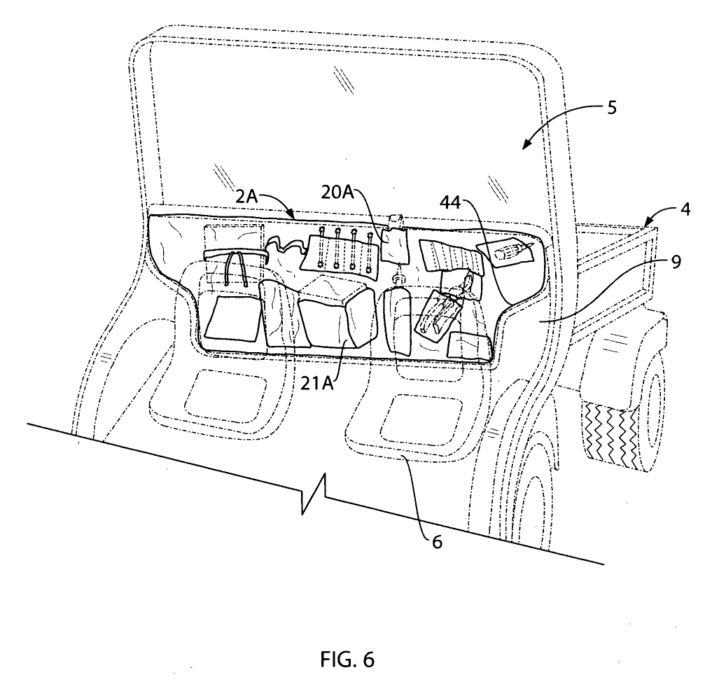

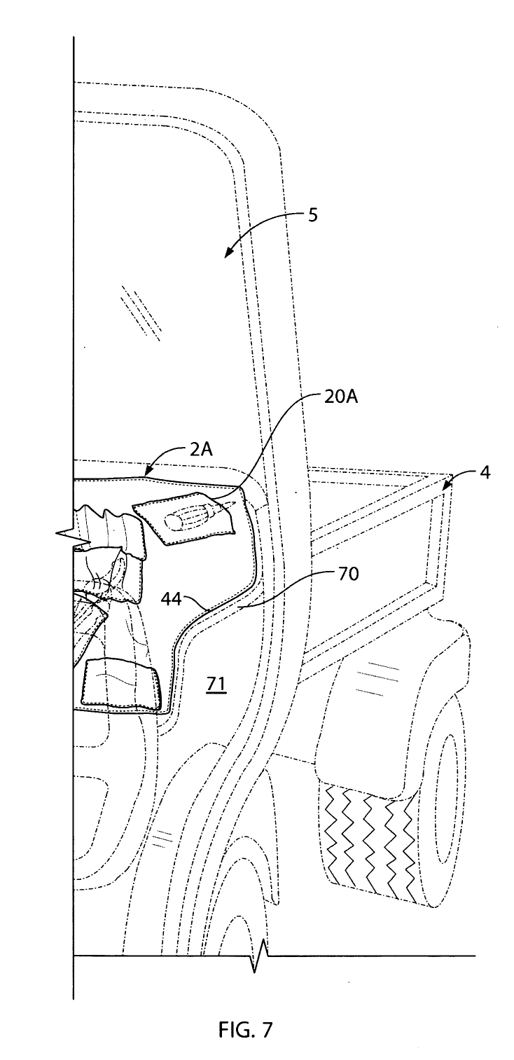

As best illustrated in FIGS. 5-8, an alternative embodiment 2A is illustrated. Storage device 2A is similar to storage device 2 in configuration and function and is characterized by having at least one conforming portion 30 configured as a conforming opening 42. Conforming opening 42 can be used either alone or in conjunction with conforming flap 32. However, instead of conforming opening 42 fitting over non-planar portion 9, conforming opening 42 circumscribes portion 9 via edge 44 (FIG. 6). As such, storage device 2A, and more particularly conforming opening 42, allows storage device 2A to be suspended from vehicle surface 7 without interfering with non-planar portion 9.

FIG. 8 illustrates storage device 2 mounted in one preferred location. As illustrated, storage device 2 is mounted behind seats 6 in cab 5 of MUV 4.

In use, storage device 2 and 2A are suspended from a vehicle surface 7, thereby allowing convenient storage and access to tools and the like. Storage devices 2 and 2A may be suspended in any manner that is well known in the art. For example, fastening systems such as, hook and loop style fasteners, grommets, snaps, or buttons may all be utilized.

Advantageously, the storage device of the present invention is efficiently fabricated while being engineered to organize, retain and allow easy access to tools and the like stored therein. Consequently, the embodiments of the preferred invention disclosed herein reveal a storage device that is easily manufactured while permitting the storage device to be disposed on surfaces and in locations that have heretofore been unable to support such devices.

The solutions offered by the invention herein have thus been attained in an economical, practical, and facile manner. To whit, a novel storage device which is cost effective, easily accessible, and capable of installation in areas which have been heretofore unable to support such devices has been invented. While preferred embodiments and example configurations of the inventions have been herein illustrated, shown, and described, it is to be appreciated that various changes, rearrangements, and modifications may be made therein, without departing from the scope of the invention as defined by the claims. It is intended that the specific embodiments and configurations disclosed herein are illustrative of the preferred and best modes for practicing the invention, and should not be interpreted as limitations on the scope of the invention as defined by the claims, and it is to appreciated that various changes, rearrangements, and modifications may be made therein, without departing from the scope of the invention as defined by the claims.

The invention claimed is:

1. A storage device for restraining items on a vehicle surface, the storage device comprising:
a panel portion comprising a first surface and a second surface adjacently disposed in opposite relation, the first surface comprising at least one storage receptacle;
a conforming portion adapted to fit adjacent at least one generally non-planer portion of a vehicle, the at least one generally non-planer portion protruding from a vehicle surface; and
wherein the storage device is adapted to be suspended from the vehicle surface such that the second surface is disposed adjacent the vehicle surface and the conforming portion is disposed adjacent the generally non-planer portion, wherein further the storage device conforms to and lies substantially against the vehicle surface including the at least one generally non-planer portion.

2. The storage device according to claim 1, wherein:
the vehicle surface includes a generally vertical wall surface disposed within a cab structure of a maintenance utility vehicle;
the cab structure having at least one bucket style seat disposed therein; and
the vehicle surface located behind the at least one bucket style seat, the generally vertical wall surface including a generally planer portion and the at least one generally non-planer portion extending from the vehicle surface.

3. The storage device according to claim 2, wherein:
the at least one storage receptacle is so positioned as to lie adjacent a side of a back of the at least one bucket style seat, the at least one storage receptacle so dimensioned as to be capable of storing an item having a depth at least as large as the largest distance between the rear of the back of the at least one bucket style seat and the vertical surface.

4. The storage device according to claim 2, wherein:
the at least one storage receptacle is so positioned as to lie behind a back of the at least one bucket style seat, the at least one storage receptacle dimensioned so as to be capable of retaining an item having a depth no larger than the smallest distance between a rear of the back of the at least one bucket style seat and the first surface of the storage device where the storage receptacle is so positioned when the storage device is suspended from the vehicle surface.

5. The storage device according to claim 1, wherein:
the at least one storage receptacle includes tie straps.

6. The storage device according to claim 1, wherein:
the conforming portion includes at least one conforming opening removed from the panel portion, the conforming opening being bordered by an edge, the edge of the conforming opening adapted to at least partially fit adjacent the at least one generally non-planer portion.

7. The storage device according to claim 6, wherein:
the conforming portion includes a pair of conforming openings removed from the panel portion.

8. The storage device according to claim 1, wherein:
the conforming portion includes at least one conforming flap, the conforming flap adapted to conform to and fit over the at least one generally non-planer portion.

9. The storage device according to claim 8, wherein:
the conforming flap includes a first portion substantially perpendicular to the panel portion, and a second portion substantially parallel to the panel portion.

10. The storage device according to claim 9, wherein:
the first portion includes at least one storage receptacle disposed thereon.

11. The storage device according to claim 10, wherein:
the second portion includes at least one storage receptacle disposed thereon.

12. A conforming storage device for use in storing and organizing items on a vehicle body surface, the vehicle body surface including a generally planer portion and at least one non-planer portion extending from the vehicle body surface, the storage device comprising:
A panel portion comprising a first surface and a second surface adjacently disposed in opposite relation, the first surface comprising at least one storage receptacle;
a conforming portion, the conforming portion adapted to conform to the at least one non-planer portion extending from the vehicle body surface; and
wherein the panel portion is adapted to be suspended from the vehicle body surface such that when the second surface is disposed adjacent the vehicle body surface and the conforming portion is disposed adjacent the at least one non-planer portion extending from the vehicle body surface, the storage device conforms to and lies substantially against the vehicle body surface including the generally planer portion and the at least one non-planer portion extending from the vehicle body surface.

13. The storage device according to claim 12, wherein:
the vehicle surface includes a generally vertical wall surface disposed within a cab structure of a maintenance utility vehicle;
the cab structure having at least one bucket style seat disposed therein; and
the vehicle body surface located behind the at least one bucket style seat, the generally vertical wall surface including a generally planer portion and the at least one non-planer portion extending from the vehicle body surface.

14. The storage device according to claim 13, wherein:
the at least one storage receptacle is so positioned as to lie adjacent a side of a back of the at least one bucket style seat, the at least one storage receptacle so dimensioned as to be capable of storing an item having a depth at least as large as the largest distance between a rear of the back of the at least one bucket style seat and the vertical surface.

15. The storage device according to claim 13, wherein:
the at least one storage receptacle is so positioned as to lie behind a back of the at least one bucket style seat, the at least one storage receptacle dimensioned so as to be capable of retaining an item having a depth no larger than the distance between a rear of the back of the at least one bucket style seat and the first surface of the storage device where the storage receptacle is so positioned when the storage device is suspended from the vehicle surface.

16. The storage device according to claim 12, wherein:
the conforming portion includes at least one conforming opening removed from the panel portion, the conforming opening being bordered by an edge, the edge of the conforming opening adapted to fit adjacent the at least one generally non-planer portion.

17. The storage device according to claim 16, wherein:
the conforming portion includes a pair of conforming openings removed from the panel portion.

18. The storage device according to claim 1, wherein:
the conforming portion includes at least one conforming flap, the conforming flap adapted to conform to and fit over the at least one generally non-planer portion.

19. The storage device according to claim 18, wherein:
the conforming flap includes, when suspended from a vehicle body surface, a first portion substantially perpendicular to the panel portion and a second portion substantially parallel to the panel portion.

20. The storage device according to claim 19, wherein:
the first portion includes at least one storage receptacle disposed thereon.

21. The storage device according to claim 19, wherein:
the second portion includes at least one storage receptacle disposed thereon.

22. A storage device adapted to be suspended in a maintenance utility vehicle, the maintenance utility vehicle having a cab structure, a pair of bucket style seats within the cab structure, and a generally vertical wall surface located behind the pair of bucket style seats, the generally vertical wall surface including a generally planer portion and a pair of non-planer portions extending from the generally vertical wall surface, the storage device comprising:
A panel portion comprising a first surface and a second surface adjacently disposed in opposite relation, the first surface comprising a plurality of storage receptacles;
A pair of conforming flaps, each conforming flap adapted to fit over and conform to each non-planer portion extending from the generally vertical wall surface; and
wherein the panel portion is adapted to be suspended from the generally vertical wall surface such that when the second surface is disposed adjacent the generally vertical wall surface and each conforming portion is disposed over each non-planer portion extending from the vehicle body surface, the storage device conforms to and lies substantially against the generally vertical wall surface including the generally planer portion and the pair of non-planer portions extending from the generally vertical wall surface.

23. The storage device according to claim 22, wherein:
at least one of the plurality of storage receptacles is so positioned as to lie between the pair of bucket style seats.

24. The storage device according to claim 22, wherein:
at least one of the plurality of storage receptacles is so dimensioned as to be capable of storing an item having a depth at least as large as the largest distance between a back surface disposed on a back of one of the bucket style seats and the generally vertical wall surface located behind the bucket style seats.

25. The storage device according to claim 22, wherein:
at least one of the plurality of storage receptacles is so positioned as to lie behind a back of one of the bucket style seats, the at least one of the plurality of storage receptacles so dimensioned as to be capable of retaining an item having a depth no larger than the distance between a back surface disposed on the back of at least one of the bucket style seats and the first surface of the storage device when the storage device is suspended from the vehicle surface.

26. The storage device according to claim 22, wherein:
the conforming flap includes a first portion substantially perpendicular to the panel portion and a second portion substantially parallel to the panel portion.

27. The storage device according to claim 26, wherein:
the first portion includes at least one storage receptacle disposed thereon.

28. The storage device according to claim 27, wherein:
the second portion includes at least one storage receptacle disposed thereon.
